(19) United States
(12) Patent Application Publication
(10) Pub. No.: US 2009/0021652 A1
(43) Pub. Date: Jan. 22, 2009

(54) MICROPROJECTOR WITH A DETACHABLE INTERACTION DEVICE

(75) Inventors: Mark A. TARLTON, Barrington, IL (US); George T. Valliath, Winnetka, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/778,997

(22) Filed: Jul. 17, 2007

(51) Int. Cl. H04N 5/64

(52) U.S. Cl. 348/836; 348/E05.128

(57) ABSTRACT

A microprojector that has a detachable interaction device is disclosed. The microprojector may include a chassis, one or more docking mechanism attached to the chassis, a detachable interaction device that attachably detaches to the one or more docking mechanism, wherein the detachable interaction device may include at least one motion sensor, a controller that processes inputs from the at least one sensor, and one or more user interface mechanisms that enable the user to interact with the detachable interaction device and control the microprojector.

### BACKGROUND OF THE DISCLOSURE

1. Field of the Disclosure

The disclosure relates to microprojector devices.

2. Introduction

Miniature projectors (a.k.a., microprojectors) can be used either as a mobile desktop projector or as a handheld device. In both cases, uses will want to interact with the projected content via point and click and control the projection device.

### SUMMARY OF THE DISCLOSURE

A microprojector that has a detachable interaction device is disclosed. The microprojector may include a chassis, one or more docking mechanism attached to the chassis, a detachable interaction device that attachably detaches to the one or more docking mechanism, wherein the detachable interaction device may include at least one motion sensor, a controller that processes inputs from the at least one sensor, and one or more user interface mechanisms that enable the user to interact with the detachable interaction device and control the microprojector.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is an diagram of an exemplary microprojector in accordance with a possible embodiment of the disclosure;

FIG. 2 is another diagram showing a different aspect of the exemplary microprojector in FIG. 1 in accordance with a possible embodiment of the disclosure;

FIG. 3 illustrates an exemplary block diagram of a microprojector in accordance with a possible embodiment of the disclosure; and

FIG. 4 is an exemplary flowchart illustrating one possible process of fabricating a microprojector in accordance with one possible embodiment of the disclosure.

### DETAILED DESCRIPTION OF THE DISCLOSURE

Additional features and advantages of the disclosure will be set forth in the description which follows, and in part will be obvious from the description, or may be learned by practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth herein.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosure comprises a variety of embodiments, such as a method and apparatus and other embodiments that relate to the basic concepts of the disclosure.

This disclosure concerns a detachable (or dockable) interaction device for a microprojector. The detachable interaction device is configured to attachably detach from the microprojector.

The embodiments in this disclosure may include multiple usage modes for both the detachable interaction device and the microprojector. In this manner, the detachable interaction device and the microprojector may have the ability to change operation modes automatically. Some of these modes may include:

A docked mode where the detachable interaction device may be physically attached to microprojector—(e.g., a flashlight pointing modes); and

An undocked mode where the microprojector may be fixed and detachable interaction device handheld such that the detachable interaction device may function as a hand-held pointer, a mouse, etc. The detachable interaction device may communicate with the microprojector or other computing device wirelessly. Movements of the interaction device control corresponding movements of the graphical pointer. One or more algorithms for converting device movements into pointer movements may be used. The choice of which algorithm is used may depend on whether the interaction device is (1) attached to the microprojector, (2) detached from the microprojector and held freely in the hand, or (3) detached from the microprojector and used on a surface such as a desktop (i.e., as a conventional mouse). The details of the individual algorithms are known to one skilled in the art.

The embodiments in this disclosure may also include self configuring/recharge capability when the detachable interaction device is docked. Bluetooth pairing may be done via the physical link when the detachable interaction device docked. The microprojector may also serve to charge the battery of the detachable interaction device when docked.

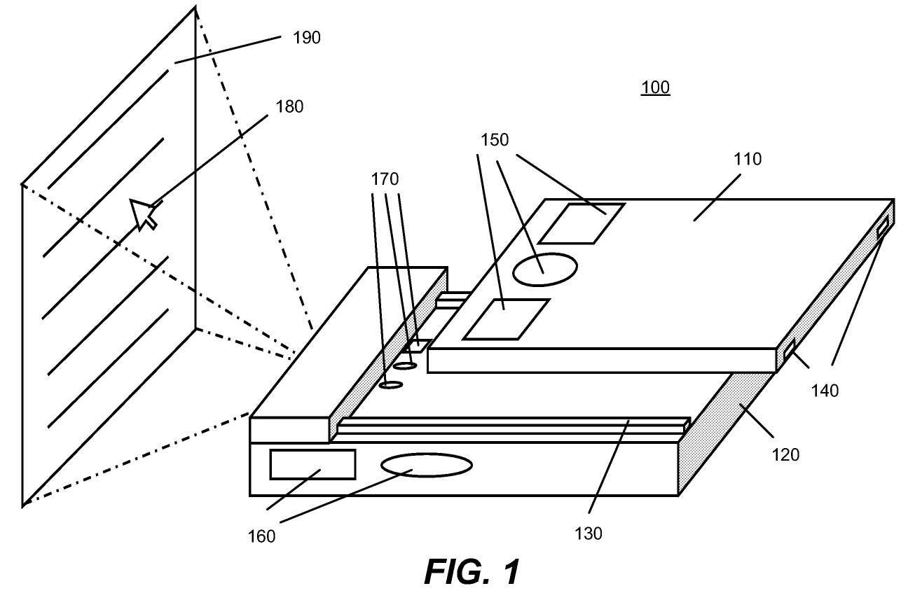

FIG. 1 is an illustration of an exemplary microprojector 100 in accordance with a possible embodiment of the disclosure. In particular, the microprojector 100 may include a microprojector chassis 120 and detachable interaction device 110 that attachably detaches to the microprojector 100, and in particular, attachably detaches to the microprojector chassis 120. The microprojector chassis 120 may further include docking guides 130, microprojector user interaction mechanisms 160, and data and power ports 170. The detachable interaction device 110 may further include docking slots 140 and detachable interaction device user interaction mechanisms 150.

The docking guides 130 on the microprojector chassis 120 and the docking slots 140 on the detachable interaction device 110 facilitate the attachment and detachment of the detachable interaction device 110 to/from the microprojector chassis 120. While FIG. 1 shows rails and slots as performing the docking function, one of skill any art may appreciate that any known or future-developed docking mechanism may be used in accordance with the spirit and scope of the invention.

Microprojector user interaction mechanisms 160 may represent buttons, wheels, etc. that may be associated with the operation of any mouse, pointer, etc. These microprojector user interaction mechanisms 160 may be operational only when the detachable interaction device 110 is docked or attached to the microprojector chassis 120. The microprojector user interaction mechanisms 160 permit a user to control the microprojector 100 so that images may be projected onto a screen 190 and permit the user to use pointer 180 during presentations, etc.

Likewise, the detachable interaction device user interaction mechanisms 150 may also represent buttons, wheels, etc. that may be associated with the operation of any mouse, pointer, etc. These detachable interaction device user interaction mechanisms 150 may be operational only when the detachable interaction device 110 is undocked or detached from the microprojector chassis 120. The detachable interaction device user interaction mechanisms 160 permit a user to control the microprojector 100 using the detachable interaction device 110 so that images may be projected onto a screen 190 and permit the user to use pointer 180 during presentations, etc.

Data and power ports 170 may be of any configuration known to one of skill in the art which enable data to be transferred between the microprojector chassis 120 and the detachable interaction device 110. Data and power ports 170 may also provide the ability for the detachable interaction device 110 to recharge its batteries while attached to the microprojector chassis 120.

The detachable interaction device 110 may also provide the user with the ability to access software or hardware menus in order to set up the projection display in a desired manner.

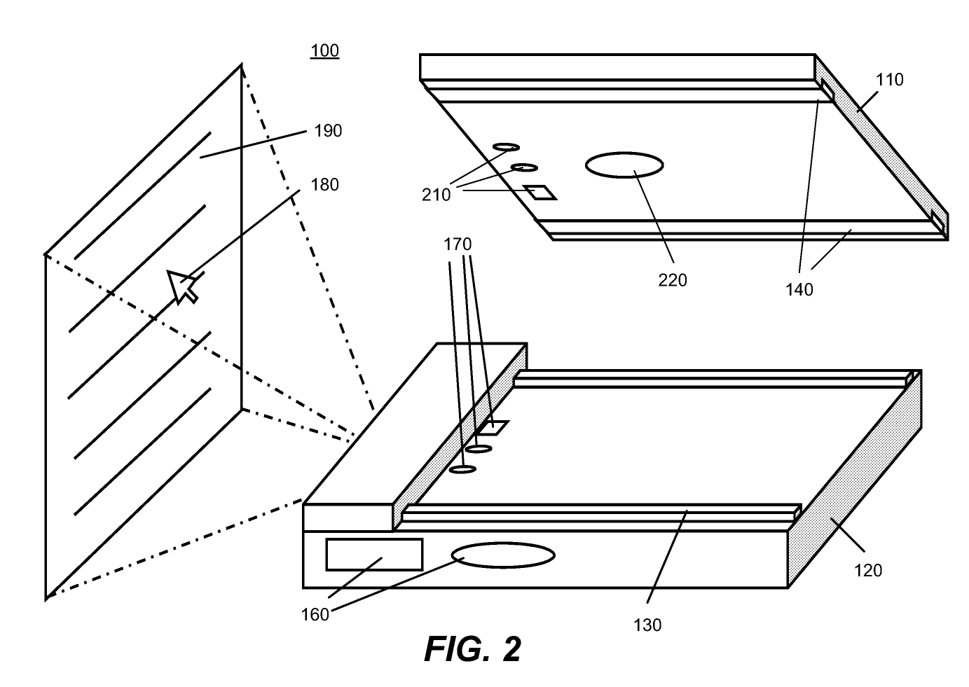

FIG. 2 is an illustration a different aspect of the exemplary microprojector 100 shown in FIG. 1 in accordance with a possible embodiment of the disclosure. In particular, FIG. 2 illustrates possible additional features of the microprojector 100 shown in FIG. 1. The additional features of the microprojector 100 may include attachable interaction device data and power ports connectors 210, and one or more motion sensors 220.

Data and power port connectors 210 may be of any configuration known to one of skill in the art which enable data to be transferred between the microprojector chassis 120 and the detachable interaction device 110. Data and power port connectors 210 may also provide the ability for the detachable interaction device 110 to recharge its batteries while attached to the microprojector chassis 120.

The one or more motion sensor 220 may represent any motion or position sensor known to one of skill in the art. For example, the motion sensor 220 may represent at least one of a gyroscopic sensor, an inertial sensor, and an optical sensor.

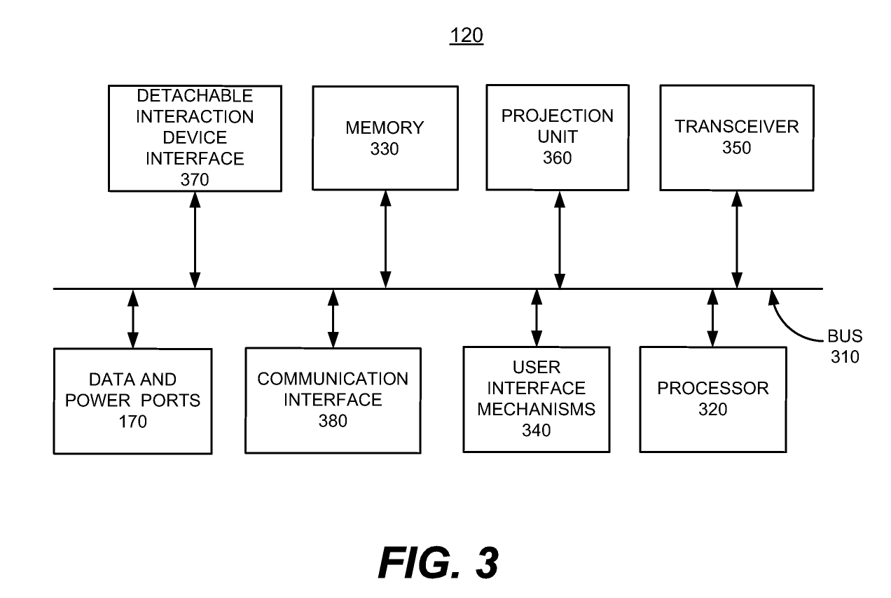

FIG. 3 illustrates a block diagram of an exemplary microprojector chassis 120 of the microprojector 100 in accordance with a possible embodiment of the invention. For example, the exemplary microprojector chassis 120 may include a bus 310, a processor 320, a memory 330, user interface mechanisms 340, transceiver 350, projection unit 360, detachable interaction device interface 370, a communication interface 380, and data and power ports 170 (as discussed above). Bus 310 may permit communication among the components of the microprojector chassis 120 and the microprojector 100.

Processor 320 may include at least one conventional processor or microprocessor that interprets and executes instructions. Memory 330 may be a random access memory (RAM) or another type of dynamic storage device that stores information and instructions for execution by processor 320. Memory 330 may also store temporary variables or other intermediate information used during execution of instructions by processor 320. The memory 330 may represent a ROM that if may include a conventional ROM device or another type of static storage device that stores static information and instructions for processor 320. The memory 330 may also represent a storage device that may include any type of media, such as, for example, magnetic or optical recording media and its corresponding drive.

User interface mechanisms 340 may include one or more mechanisms that permit a user to input information to, such as a keyboard, a mouse, a pen, a voice recognition device, microprojector user interaction mechanisms 160, etc.

Communication interface 380 may include any mechanism that enables the microprojector 100 and microprojector chassis 120 to work with transceiver 350 in order communicate wired or Tirelessly with other local devices such as the detachable interaction device, or another remote device via a network. For example, communication interface 380 may include a WiFi device, a modem, or an Ethernet interface communicating device that may allow the transceiver 350 to communicate directly with a device (such as the detachable interaction device 110), or to communicate through a local area network (LAN). Alternatively, communication interface 380 may include other mechanisms for communicating with other devices and/or systems via wired, wireless or optical connections. In some implementations of the microprojector 100, communication interface 380 may not be included in the exemplary microprojector chassis 120 and may be part of an external device such as a computer, for example.

Projection unit 360 may represent the devices that permit images to be projected and viewed on a screen 190. In particular, the projection unit 360 may represent any series or combination of light sources, optics, opto-mechanical components, matrix displays, etc. that permit images to be projected by a microprojector 100, as known to those of skill in the art.

The detachable interaction device interface 370 may represent any interface that will enable communication between the detachable interaction device 110 and the microprojector chassis 120. This communication may include docking signals, power and data transfer signals, projector control signals, mouse button signals, mouse navigation signals, pointer signals, etc.

The microprojector 100 may perform such functions in response to processor 320 by executing sequences of instructions contained in a computer-readable medium, such as, for example, memory 330, a magnetic disk, or an optical disk. Such instructions may be read into memory 330 from another computer-readable medium, such as storage device 350, or from a separate device via communication interface 380.

For illustrative purposes, the microprojector fabrication process will be described below in relation to the diagrams shown in FIGS. 1-3.

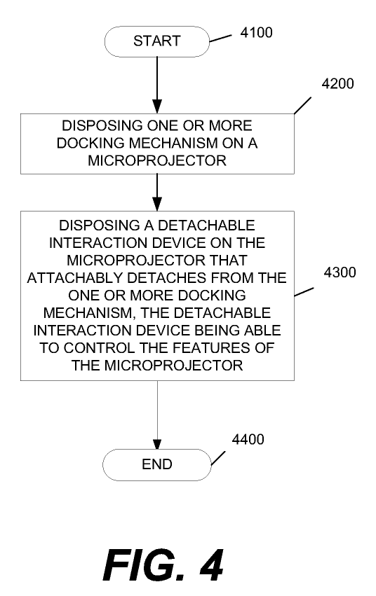

FIG. 4 is an exemplary flowchart illustrating some of the basic steps associated with a microprojector fabrication process in accordance with a possible embodiment of the disclosure. The process begins at step 4100 and continues to step 4200 where the process disposes one or more docking mechanism on the microprojector. At step 4300; the process disposes a detachable interaction device on the microprojector that attachably detaches from the one or more docking mechanisms, the detachable interaction device being able to control the features of the microprojector. The process goes to step 4500 and ends.

Although the above description may contain specific details, they should not be construed as limiting the claims in any way. Other configurations of the described embodiments of the disclosure are part of the scope of this disclosure. For example, the principles of the disclosure may be applied to each individual user where each user may individually deploy such a system. This enables each user to utilize the benefits of the disclosure even if any one of the large number of possible applications do not need the functionality described herein. In other words, there may be multiple instances of the detachable interaction device in FIGS. 1-3 each processing the content in various possible ways. It does not necessarily need to be one system used by all end users. Accordingly, the appended claims and their legal equivalents should only define the disclosure, rather than any specific examples given.

We claim:

1. A microprojector, comprising:
a chassis;
one or more docking mechanism attached to the chassis;
a detachable interaction device that attachably detaches to the one or more docking mechanism, wherein the detachable interaction device comprises:
at least one motion sensor;
a controller that processes inputs from the at least one sensor; and
one or more user interface mechanisms that enable the user to interact with the detachable interaction device and control the microprojector.

2. The microprojector of claim 1, wherein the chassis includes one or more user interface mechanisms that enable the user to control the microprojector.

3. The microprojector of claim 2, wherein the one or more user interface mechanisms included on the chassis enable the user to control the microprojector only when the detachable interaction device is attached to the microprojector.

4. The microprojector of claim 1, wherein the at least one motion sensor is at least one of a gyroscopic sensor, an inertial sensor, and an optical sensor.

5. The microprojector of claim 1, wherein the microprojector includes wireless communication capability and the detachable interaction device communicating wirelessly to the microprojector.

6. The microprojector of claim 1, wherein the microprojector includes battery recharging capability and the detachable interaction device's battery being recharged when attached to the microprojector.

7. The microprojector of claim 1, wherein the one or more interface mechanisms are buttons located on at least one the sides and top of the detachable interaction device.

8. A detachable interaction device that is used with a microprojector, comprising:
at least one motion sensor;
a controller that processes inputs from the at least one sensor; and
one or more user interface mechanisms that enable a user to interact with the detachable interaction device and control the microprojector, wherein the detachable interaction device attachably detaches to the one or more docking mechanism.

9. The detachable interaction device of claim 8, further comprising:
a body having at least two sides, a top and a bottom; and
one or more docking mechanism attached to the body that facilitate attaching and detaching from the microprojector.

10. The detachable interaction device of claim 9, wherein the one or more interface mechanisms are buttons located on at least one the top and the sides of the detachable interaction device.

11. The detachable interaction device of claim 8, wherein the one or more user interface mechanisms enable the user to control the microprojector only when the detachable interaction device is attached to the microprojector.

12. The detachable interaction device of claim 8, wherein the at least one motion sensor is at least one of a gyroscopic sensor, an inertial sensor, and an optical sensor.

13. The detachable interaction device of claim 8, wherein the detachable interaction device communicates wirelessly to the microprojector.

14. The detachable interaction device of claim 8, further comprising:
a battery, wherein the detachable interaction device's battery is recharged when attached to the microprojector.

15. A method of fabricating a microprojector, comprising:
disposing one or more docking mechanism on the microprojector; and
disposing a detachable interaction device on the microprojector that attachably detaches from the one or more docking mechanism, the detachable interaction device being able to control the features of the microprojector.

16. The method of claim 15, further comprising:
disposing one or more user interface mechanisms on the detachable interaction device that enable the user to control the microprojector.

17. The method of claim 15, wherein the one or more interface mechanisms are buttons located on at least one the sides and top of the detachable interaction device.

18. The method of claim 15, further comprising:
disposing at least one motion sensor on the detachable interaction device, wherein the at least one motion sensor is at least one of a gyroscopic sensor, an inertial sensor, and an optical sensor.

19. The method of claim 15, further comprising:
disposing wireless communication capability on the microprojector to enable the detachable interaction device to communicate wirelessly with the microprojector.

20. The method of claim 15, further comprising:
disposing battery recharging capability on the microprojector to enable the detachable interaction device's battery to be being recharged when attached to the microprojector.
